(19) United States
(12) Patent Application Publication
(10) Pub. No.: US 2024/0377978 A1
(43) Pub. Date: Nov. 14, 2024

(54) STORAGE MANAGEMENT DEVICE FOR VEHICLE

(71) Applicant: TOYOTA JIDOSHA KABUSHIKI KAISHA, Toyota-shi (JP)

(72) Inventors: Junichiro TAMAO, Tokyo (JP); Takahiro UTSUNOMIYA, Tokyo (JP); Takumi HORIE, Chofu-shi (JP); Tomoaki KARASAWA, Matsudo-shi (JP); Norihide KOHMOTO, Nisshin-shi (JP)

(73) Assignee: TOYOTA JIDOSHA KABUSHIKI KAISHA, Toyota-shi (JP)

(21) Appl. No.: 18/632,508

(22) Filed: Apr. 11, 2024

(30) Foreign Application Priority Data
May 9, 2023 (JP) 2023-077114

(51) Int. Cl. G06F 3/06

(52) U.S. Cl. CPC G06F 3/0644; G06F 3/0604; G06F 3/0673

(57) ABSTRACT

A storage management device for a vehicle includes a processor and a memory. The processor is configured to store, in the memory, data corresponding to an operation of each vehicle on-board system in which one of multiple functional safety levels is set in advance. The memory includes a first partition and a second partition allocated in advance. The first partition is configured to store data corresponding to an operation of a vehicle on-board system for which a functional safety level lower than a predetermined specific level is set. The second partition is configured to store data corresponding to an operation of a vehicle on-board system for which a functional safety level higher than or equal to the specific level is set.

### BACKGROUND

### 1. Field

The present disclosure relates to a storage management device for a vehicle.

### 2. Description of Related Art

A vehicle controller disclosed in Japanese Laid-Open Patent Publication No. 2022-065218 includes a database and a cache as storage areas. The controller executes multiple applications. A functional safety level that is an indicator of functional safety for automobiles is set for each application. When executing an application, the controller changes a mode of storing an execution result of the application according to the functional safety level of the application. The controller temporarily stores the execution result of the application with a low functional safety level in a cache. Thereafter, the controller moves the execution result to the database. In contrast, the controller directly stores an execution result of an application with a high functional safety level in the database. As a result, the controller ultimately writes the execution result of the application with the low functional safety level and the execution result of the application with the high functional safety level to the same database.

There is an upper limit to the number of times data can be written to a database. Thus, when data having different functional safety levels are written to the same database as in the above-described publication, the following problems arise. A case is now considered in which the frequency of writing data of a first functional safety level is high, while the frequency of writing data of a second functional safety level is low. In this case, even if the data of the second functional safety level is not written to the database very frequently, the high frequency of writing data of the first functional safety level can cause the number of times data can be written to the database to reach the upper limit That is, the writing of the data of the first functional safety level can hinder the writing of the data of the second functional safety level.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a storage management device for a vehicle includes a processor and a memory. The processor is configured to store, in the memory, data corresponding to an operation of each vehicle on-board system in which one of multiple functional safety levels is set in advance. The memory includes a first partition and a second partition allocated in advance. The first partition is configured to store data corresponding to an operation of a vehicle on-board system for which a functional safety level lower than a predetermined specific level is set. The second partition is configured to store data corresponding to an operation of a vehicle on-board system for which a functional safety level higher than or equal to the specific level is set.

Other features and aspects will be apparent from the following detailed description, the drawings, and the claims.

### BRIEF DESCRIPTION OF THE DRAWINGS

FIG. 1 is a schematic diagram showing a configuration of a vehicle according to an embodiment.

FIG. 2 is a schematic diagram illustrating a setting of partitions of the first memory shown in FIG. 1.

FIG. 3 is a sequence diagram showing a flow in which the central ECU shown in FIG. 1 stores data.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a storage management device for a vehicle will be described with reference to the drawings.

### Overall Configuration of Vehicle

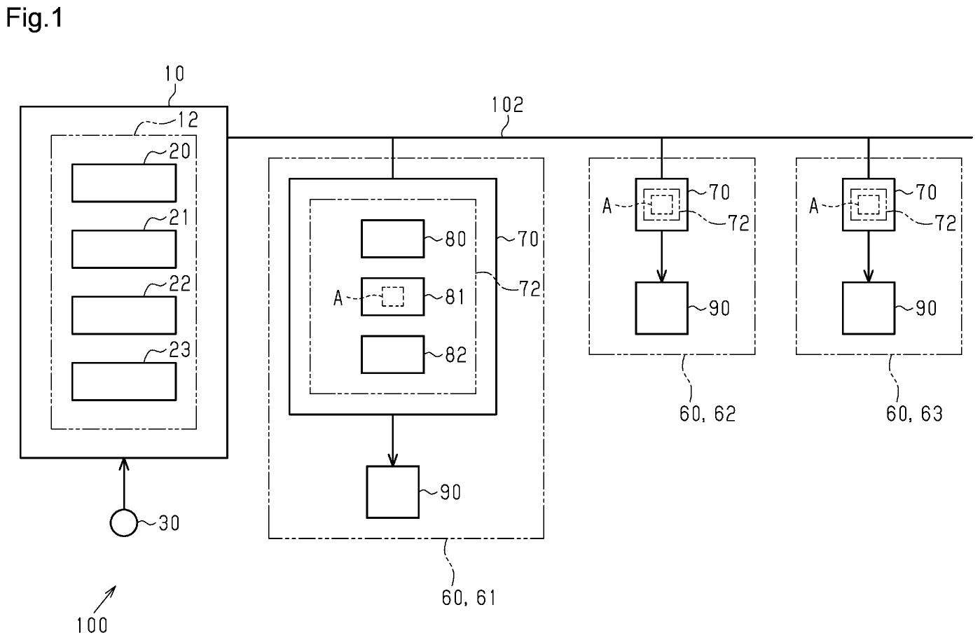

As shown in FIG. 1, the vehicle 100 includes a central ECU 10. The central ECU 10 is a controller that comprehensively controls the entire vehicle 100. The central ECU 10 includes processing circuitry 12. The processing circuitry 12 includes a CPU 20, a first memory 21, a second memory 22, and a third memory 23. The first memory 21 is a nonvolatile memory. The first memory 21 functions as a storage. The second memory 22 is a nonvolatile memory. The second memory 22 stores in advance various programs describing processes to be executed by the CPU 20. The third memory 23 is a volatile memory. The CPU 20, the first memory 21, the second memory 22, and the third memory 23 can communicate with each other. The CPU 20 is an execution unit. The first memory 21 is a storage unit. The central ECU 10 is a storage management device for vehicles. ECU is an abbreviation of Electronic Control Unit.

The vehicle 100 includes multiple information acquisition devices 30. In FIG. 1, one of the multiple information acquisition devices 30 is representatively shown. The information acquisition devices 30 are devices that acquire various types of information related to the vehicle 100. The various types of information include surroundings monitoring information of the vehicle 100, information related to a traveling state of the vehicle 100, information on an operation state of a vehicle on-board device 90 described later, and the like. An example of the information acquisition devices 30 is a camera that images the surroundings of the vehicle 100. An example of the information acquisition devices 30 is a sensor that detects the traveling speed of the vehicle 100. An example of the information acquisition devices 30 is a sensor that detects a hydraulic pressure of a brake device mounted on the vehicle 100. Each information acquisition device 30 outputs a signal corresponding to the information acquired by itself.

### Vehicle On-Board System

The vehicle 100 includes multiple vehicle on-board systems 60. The vehicle on-board system 60 includes a vehicle on-board device 90 and a base ECU 70 that controls the vehicle on-board device 90. The vehicle on-board device 90 realizes various functions by operating in response to an electric signal from the base ECU 70. The various functions include functions necessary for traveling of the vehicle 100. The various functions include those that enhance occupant safety and comfort. Examples of the vehicle on-board device 90 include an engine, a brake device, a power steering device, an airbag device, a suspension device, and a car navigation device.

The base ECU 70 includes processing circuitry 72. The processing circuitry 72 includes a CPU 80, a nonvolatile memory 81, and a volatile memory 82. The nonvolatile memory 81 stores in advance various programs describing processes to be executed by the CPU 80. An example of the various programs is an application A for operating the vehicle on-board device 90 to be controlled. In the present embodiment, it is assumed that one application A is stored in the nonvolatile memory 81 for one base ECU 70. The CPU 80, the nonvolatile memory 81, and the nonvolatile memory 82 can communicate with each other. The processing circuitry 72 may include a nonvolatile memory for storage in addition to the nonvolatile memory 81. In FIG. 1, details of the processing circuitry 72 are shown for only one base v. The base ECU 70 is connected to the central ECU 10 via a bus 102. The base ECU 70 is in communication with the central ECU 10.

One base ECU 70 basically controls one vehicle on-board device 90. Depending on the content of the application A, one base ECU 70 may compositely control several vehicle on-board devices 90. In this case, a group of these constitutes one vehicle on-board system 60. In short, the vehicle on-board system 60 includes a group of an application A for realizing a specific function, a base ECU 70 that executes the application A, and one or more vehicle on-board devices 90 that operate in response to the execution of the application A by the base ECU 70.

In each vehicle on-board system 60, the base ECU 70 generates various kinds of information to operate the vehicle on-board device 90. The generating includes obtaining information from the information acquisition devices 30 and using the information as the information handled by the base ECU 70. Generating the data includes calculating a control amount for the vehicle on-board device 90. Generating the data includes generating failure information when a failure occurs in the vehicle on-board device 90. Hereinafter, with respect to a certain vehicle on-board system 60, the datum generated by the base ECU 70 in response to the operation of the vehicle on-board device 90 by the base ECU 70 is referred to as the datum corresponding to the operation of the vehicle on-board system 60.

One of multiple functional safety levels is set in advance for each vehicle on-board system 60. The functional safety levels are defined as indicators of functional safety in the international standard for automobiles, ISO26262. Specifically, the functional safety levels are categorized into five stages: QM and ASIL-A to ASIL-D. The hierarchy of these levels increases in the order of QM, ASIL-A, ASIL-B, ASIL-C, to ASIL-D. QM is an abbreviation for quality management. ASIL is an abbreviation for automotive safety integrity level.

The vehicle on-board systems 60 can be broadly classified into three types based on the functional safety levels set for each: first systems 61, second systems 62, and third systems 63. The first systems 61 are vehicle on-board systems 60 for which QM is set as the functional safety level. The second systems 62 are vehicle on-board systems 60 for which any one of ASIL-A, ASIL-B, and ASIL-C is set as the functional safety level. The third systems 63 are vehicle on-board systems 60 for which ASIL-D is set as the functional safety level. There are multiple first systems 61, multiple second systems 62, and multiple third systems 63. FIG. 1 representatively shows one of the first systems 61. The same applies to the second systems 62 and the third systems 63. In the following description, when each of the three types of the vehicle on-board systems 60 is described, the individual names thereof will be used. When the three types of the vehicle on-board systems 60 are collectively described, they are referred to as the vehicle on-board systems 60.

### Details of First Memory of Central ECU

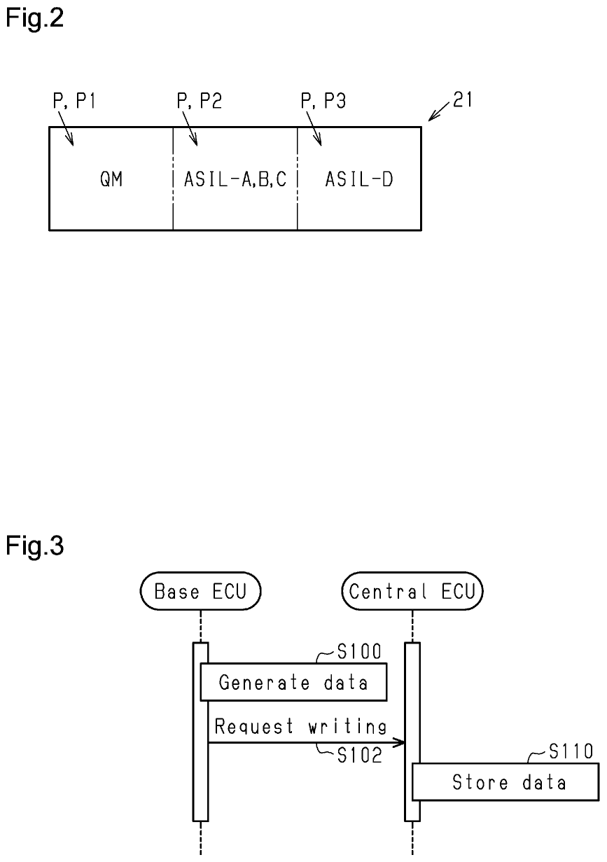

As shown in FIG. 2, the first memory 21 of the central ECU 10 includes three partitions P allocated in advance. Specifically, the first memory 21 includes a first partition P1, a second partition P2, and a third partition P3. These three partitions P are storage areas already allocated to the first memory 21 when the vehicle 100 is shipped from the factory. In the following description, when each of the three partitions P is described, the individual names thereof will be used. When the three partitions P are collectively described, they are referred to as the partitions P.

The first partition P1 can store data corresponding to operation of the first systems 61. The first partition Pl stores only data corresponding to operation of the first systems 61. Specifically, the first partition P1 is a storage area dedicated for the data corresponding to operation of the vehicle on-board systems 60 for which the lowest functional safety level is set. The first partition P1 is assigned the number 1 as a dedicated number for designating the first partition P1.

The second partition P2 can store data corresponding to operation of the second systems 62. The second partition P2 stores only data corresponding to operation of the second systems 62. Specifically, the second partition P2 is a storage area dedicated for the data corresponding to operation of the vehicle on-board systems 60 except the first systems 61 and the third systems 63. The second partition P2 is assigned the number 2 as a dedicated number for designating the second partition P2.

The third partition P3 can store data corresponding to operation of the third systems 63. The third partition P3 stores only data corresponding to operation of the third systems 63. Specifically, the third partition P3 is a storage area dedicated for the data corresponding to operation of the vehicle on-board systems 60 for which the highest functional safety level is set. The third partition P3 is assigned the number 3 as a dedicated number for designating the third partition P3.

The second memory 22 of the central ECU 10 stores in advance a correspondence relationship between the designated numbers assigned to the respective each partitions P and a range of the actual storage areas. This correspondence relationship is referred to as memory information.

The three partitions P can be described as follows. The first partition P1 is a storage area for the vehicle on-board systems 60 for which a functional safety level lower than a first specific level is set. The second partition P2 is a storage area for the vehicle on-board systems 60 for which a functional safety level higher than or equal to the first specific level and lower than a second specific level is set. The third partition P3 is a storage area for the vehicle on-board systems 60 for which a functional safety level higher than or equal to the second specific level is set. The first specific level is predetermined as ASIL-A. The second specific level is predetermined as ASIL-D.

### Specific Identifier

The base ECU 70 of each vehicle on-board system 60 stores the date generated in response to the operation of the vehicle on-board device 90 in the first memory 21 of the central ECU 10 as necessary. At this time, the base ECU 70 designates the partition P of the storage destination for the central ECU 10. The base ECU 70 uses a specific identifier to designate the partition P as a data-storage destination. This specific identifier will be described below.

The base ECU 70 pre-stores the specific identifier. The specific identifier is assigned in advance to each vehicle on-board system 60. The specific identifier is a combination of three first information, the second information, and the third information.

The first information is information indicating the target vehicle on-board system 60. The first information is an individual number for each vehicle on-board system 60 for distinguishing the target vehicle on-board system 60 from the other vehicle on-board systems 60.

The second information is information indicating a functional safety level set in the target vehicle on-board system 60. In other words, the second information indicates any one of QM and ASIL-A to ASIL-D. For example, the second information is obtained by quantifying the functional safety level in ascending order. For example, 1 is assigned to the lowest functional safety level. Then, as the functional safety level increases, a numerical value that increases by one is assigned.

The third information is information indicating the partition P of the storage destination of the data. The information indicating the partition P is the number of the partition P. That is, when the target vehicle on-board system 60 is the first system 61, the information indicating the partition P is 1. When the target vehicle on-board system 60 is the second system 62, the information indicating the partition P is 2. When the target vehicle on-board system 60 is the third system 63, the information indicating the partition P is 3.

### Flow of Data Storage

Data corresponding to an operation of a certain vehicle on-board system 60 is referred to as first data. The central ECU 10 stores the first datum in the first memory 21 in the following flow. As shown in step S100 of FIG. 3, it is assumed that the base ECU 70 generates the first datum. Upon generating the first datum, the base ECU 70 performs the processing of step S102. In step S102, the base ECU 70 sends a write request to the central ECU 10. The write request includes the first data, the specific identifier, and an instruction signal for instructing to store the first data.

Upon receiving the write request, the central ECU 10 performs the processing of step S110. In step S110, the CPU 20 of the central ECU 10 performs a writing process. To be specific, the CPU 20 refers to the specific identifier among the information included in the write request. Then, based on the specific identifier, the CPU 20 specifies the number of the partition P in which the first datum is to be stored. Then, the CPU 20 writes the first datum into the partition P of the specified number in the first memory 21. At this time, the CPU 20 refers to the memory information described above. Thereby, the CPU 20 grasps the range of the actual storage area to be written. As described above, the CPU 20 stores the write-requested first datum in the first memory 21.

The process of storing the information in the first memory 21 of the central ECU 10 is described above by taking one information as an example. The CPU 20 of the central ECU repeats the above-described writing process in response to the writing request sequentially transmitted from each vehicle on-board system 60. Accordingly, the number of times of writing to each partition P increases.

### Operation of Embodiment

It is assumed that the base ECU 70 of one third system 63 generates a datum. For example, the base ECU 70 acquires a captured image of a camera. When storing a captured image in the first memory 21 of the central ECU 10, the base ECU 70 transmits a write request to the central ECU 10. In the specific identifier included in the write request, 3 is set as the number of the partition P designating the storage destination of the data. In response to the write request, the CPU 20 of the central ECU 10 stores the captured image in the third partition P3 of the first memory 21.

### Advantages of Embodiment

(1) Each partition P has an upper limit of the number of times data is written. If the data of the three types of vehicle on-board systems 60 are written in a common partition, the following problem may occur. That is, it is assumed that the data write frequency of the first system 61 is higher than the data write frequency of the third system 63. In this case, even in a situation where the data of the third system 63 is not written to the common partition so much, the number of times of writing to the common partition may reach the upper limit due to the high frequency of writing of the data of the first system 61 to the common partition.

In this regard, the first memory 21 of the central ECU 10 according to the present embodiment includes a dedicated partition P for each of the first system 61, the second system 62, and the third system 63. The number of times of writing is independent between the respective partitions P. Therefore, when the dedicated partition P is provided for each type of the vehicle on-board system 60, the following is possible. That is, with respect to the three types of vehicle on-board systems 60, it is possible to prevent writing of data of one type of vehicle on-board system 60 from adversely affecting writing of data of another type of vehicle on-board system 60.

(2) The data of the vehicle on-board system 60 having a high functional safety level tends to have higher importance than the data of the vehicle on-board system 60 having a low functional safety level. In this embodiment, the first memory 21 of the central ECU 10 includes a first partition Pl dedicated to the first system 61. Therefore, it is possible to prevent writing of data of low importance from adversely affecting writing of data of higher importance.

(3) In addition to (2), the first memory 21 of the central ECU 10 includes a third partition P3 dedicated to the third system 63. In this embodiment, it is possible to reliably secure a write area for data having a particularly high importance.

### Modifications

The above-described embodiment may be modified as follows. The above-described embodiments and the following modifications can be combined as long as the combined modifications remain technically consistent with each other.

The base ECU 70 may store multiple applications A. In this case, even if the combination of the base ECU 70 and the vehicle on-board device 90 is the same, the vehicle on-board device 90 can realize different functions depending on the content of the application A executed by the base ECU 70. In such a case, the base ECU 70 and the vehicle on-board device 90 may be treated as configuring an individual vehicle on-board system 60 for each function to be realized. In a case where the base ECU 70 stores multiple applications A, the base ECU 70 may store a specific identifier for each stored application A and thus for each vehicle on-board system 60.

When the base ECU 70 stores multiple applications A, the base ECU 70 may control a different vehicle on-board device 90 for each application A. In this case, the vehicle on-board system 60 may be determined for each combination of the base ECU 70 and the vehicle on-board device 90 with reference to the application A.

Regarding the specific identifier, the information indicating the vehicle on-board system 60 is not limited to the example of the above-described embodiment. That is, the information indicating the vehicle on-board system 60 may not be a number. The information indicating the vehicle on-board system 60 may be any information that allows a certain vehicle on-board system 60 to be distinguished from other vehicle on-board systems 60. The same applies to the information indicating the functional safety level and the information indicating the partition P. In other words, the information indicating the functional safety level and the information indicating the partition P are not limited to those using numbers.

In the above-described embodiment, when the CPU 20 of the central ECU 10 stores the date in the first memory 21, the CPU 20 selects the partition P to store the date based on the specific identifier. However, the mode of processing when the CPU 20 selects the partition P is not limited to the example of the embodiment described above. As long as a predetermined partition P can be appropriately selected in accordance with the correspondence with the functional safety level, a method of processing when the partition P is selected may be changed from the example of the above-described embodiment. For example, the following mode may be adopted.

It is assumed that the specific identifier included in the write request by the base ECU 70 includes only the first information in the above embodiment. That is, the specific identifier is an individual number for each vehicle on-board system 60. The second memory 22 of the central ECU 10 stores a management list in advance. The management list is a table in which the following two pieces of information are associated with each other. One piece of information is an individual number for each vehicle on-board system 60. The other information is the number of the partition P in which data from each vehicle on-board system 60 is to be stored.

Under the above assumption, when the CPU 20 of the central ECU 10 receives a write request from the vehicle on-board system 60, it selects a partition P to be stored in data as follows. First, the CPU 20 refers to the specific identifier transmitted from the vehicle on-board system 60 and the management list. Then, the CPU 20 specifies the partition P corresponding to the specific identifier in the management list. Thereafter, the CPU 20 stores the write-requested datum in the specified partition P. As a mode of processing when the CPU 20 selects the partition P, such a processing method may be employed.

The method of setting the partition P in the first memory 21 is not limited to the example of the embodiment described above. The partition P may be set in any manner as long as the following predetermined conditions are satisfied. The predetermined items are the following four items. (1) The first memory 21 includes at least two partitions P. (2) One of the two partitions P can store data corresponding to an operation of the vehicle on-board system 60 to which a functional safety level lower than a predetermined specific level is set. (3) The other of the two partitions P can store data corresponding to the operation of the vehicle on-board system 60 to which a functional safety level higher than or equal to a specific level is set. (4) The specific level is a level higher than the lowest functional safety level. As long as such predetermined items are satisfied, the method of assigning the functional safety level to be stored in each partition P may be changed from the example of the embodiment described above. In addition, the number of partitions P set in the first memory 21 may be changed from the example of the above-described embodiment as long as the above-described predetermined condition is satisfied.

As described above, the number of partitions P set in the first memory 21 is not limited to the example of the above embodiment. For example, five partitions P may be provided corresponding to five functional safety levels, respectively. That is, the partition P may be provided for each functional safety level. In this case, a first additional partition and a second additional partition are provided in the first memory 21 in addition to the first partition P1, the second partition P2, and the third partition P3. The first partition P1 is a storage area dedicated to the vehicle on-board system 60 to which the lowest functional safety level is set. The third partition P3 is a storage area dedicated to the vehicle on-board system 60 to which the highest functional safety level is set. The remaining three partitions P are storage areas dedicated to the vehicle on-board systems 60 having different functional safety levels. Even when five partitions P are set as described above, a specific identifier or a management list may be configured so that each partition P can be distinguished from each other.

The method of assigning the functional safety level to be stored in each partition P is not limited to the example of the embodiment described above. For example, in the case where three partitions P are provided as in the above embodiment, ASIL-C may be set in addition to ASIL-D as the functional safety level to be stored in the third partition P3. That is, it is not essential that the third partition P3 is dedicated to the vehicle on-board system 60 having the highest functional safety level. For example, if the number of times of data writing by the vehicle on-board system 60 whose functional safety level is ASIL-C is considerably small, the following situation hardly occurs. In this case, the writing of the data of the vehicle on-board system 60 whose functional safety level is ASIL-C becomes an adverse effect on the writing of the data of the vehicle on-board system 60 whose functional safety level is ASIL-D. Therefore, if it is known in advance that the number of times of data writing by the vehicle on-board system 60 whose functional safety level is ASIL-C is considerably small, data of both the vehicle on-board system 60 whose functional safety level is ASIL-C and the vehicle on-board system 60 whose functional safety level is ASIL-D may be set to be stored in the same partition P.

It is not essential that the first partition P1 is dedicated to the vehicle on-board system 60 having the lowest functional safety level. For example, ASIL-A may be set in addition to QM as the functional safety level to be stored in the first partition P1. If it is known in advance that the number of in advance that the number of times of data writing by the vehicle on-board system 60 whose functional safety level is QM is considerably small, such a setting is also possible.

The number of functional safety levels and the method of determining the functional safety levels are not limited to the example of the above embodiment. Two or more functional safety levels may be defined.

The central ECU 10 may store an application A for operating the vehicle on-board device 90. Then, the central ECU 10 itself may constitute the vehicle on-board system 60 together with the vehicle on-board device 90 to be controlled. In this case, the CPU 20 of the central ECU 10 may store the date generated in response to the operation of the vehicle on-board device 90 in an appropriate partition P in the first memory 21.

In the central ECU 10, the first memory 21 and the second memory 22 may be combined into one memory. In this case, one memory may be provided with an area for storing various programs describing processes to be executed by the CPU 20, in addition to an area for storing information from each vehicle on-board system 60.

The configuration of the processing circuitry 12 in the central ECU 10 is not limited to the example of the embodiment described above. The processing circuitry 12 may have any one of the following configurations (a) to (c) on the assumption that the processing circuitry 12 includes a storage unit and an execution unit as described below. The storage unit satisfies the predetermined items described above. The execution unit stores data corresponding to the operation of the vehicle on-board system 60 in the partition P. At this time, the execution unit selects a partition P determined in advance according to the correspondence with the functional safety level as a data storage target.

(a) The processing circuitry 12 includes one or more processors that execute various processes in accordance with a computer program. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.

(b) The processing circuitry 12 includes one or more exclusive hardware circuits that execute various processes. The dedicated hardware circuits include, for example, an application specific integrated circuit (ASIC) and a field programmable gate array (FPGA). ASIC is an abbreviation of an application specific integrated circuit. FPGA is an abbreviation of a field programmable gate array.

(c) The processing circuitry 12 includes one or more processors that execute part of various processes according to programs and one or more dedicated hardware circuits that execute the remaining processes.

The processing circuitry 72 of each base ECU 70 may have any one of the above-described configurations (a) to (c) on the premise that the processing circuitry 72 can appropriately control the vehicle on-board device 90 to be controlled and can transmit the data-write request to the central ECU 10.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A storage management device for a vehicle, comprising a processor and a memory, wherein
the processor is configured to store, in the memory, data corresponding to an operation of each vehicle on-board system in which one of multiple functional safety levels is set in advance,
the memory includes a first partition and a second partition allocated in advance,
the first partition is configured to store data corresponding to an operation of a vehicle on-board system for which a functional safety level lower than a predetermined specific level is set, and
the second partition is configured to store data corresponding to an operation of a vehicle on-board system for which a functional safety level higher than or equal to the specific level is set.

2. The storage management device for a vehicle according to claim 1, wherein
the multiple functional safety levels include three or more functional safety levels, and
the first partition is an area configured to store only data corresponding to an operation of a vehicle on-board system for which a lowest functional safety level is set, and
the second partition is an area configured to store only data corresponding to an operation of any vehicle on-board system except the vehicle on-board system for which the lowest functional safety level is set.

3. The storage management device for a vehicle according to claim 1, wherein
the multiple functional safety levels include three or more functional safety levels, and
the memory further includes a third partition allocated in advance, and
the third partition is an area configured to store only data corresponding to an operation of a vehicle on-board system for which a highest functional safety level is set.
